(19) United States
(12) Patent Application Publication
(10) Pub. No.: US 2011/0187827 A1
(43) Pub. Date: Aug. 4, 2011

(54) METHOD AND APPARATUS FOR CREATING A STEREOSCOPIC IMAGE

(75) Inventors: Robert Mark Stefan Porter, Winchester (GB); Stephen Mark Keating, Lower Earley (GB); Clive Henry Gillard, Medstead (GB)

(73) Assignee: Sony Corporation, Tokyo (JP)

(21) Appl. No.: 12/976,283

(22) Filed: Dec. 22, 2010

(30) Foreign Application Priority Data
Jan. 29, 2010 (GB) 1001555.0

(51) Int. Cl. H04N 13/02

(52) U.S. Cl. 348/46; 348/E13.074

(57) ABSTRACT

A method of creating a stereoscopic image for display comprising the steps of: receiving a first image and a second image of the same scene captured from the same location, the second image being displaced from the first image by an amount; and transforming the second image such that at least some of the second image is displaced from the first image by a further amount; and outputting the first image and the transformed second image for stereoscopic display is disclosed. A corresponding apparatus is also disclosed.

### BACKGROUND OF THE INVENTION

1. Field of the Invention

The present invention relates to a method, apparatus and computer program for creating a stereoscopic image.

2. Description of the Prior Art

Presently, stereoscopic images which are used to generate images having a 3 dimensional effect are captured using a camera rig. The 3 dimensional effect is achieved by spacing two cameras a predetermined distance apart and by each camera having the same focal length. The distance between the cameras is set so that the maximum positive distance between the two images, when displayed, is no greater than the distance between the viewer's eyes. The distance between a viewer's eyes is sometimes called the “interpupilary distance”. This is typically 6.5 cm.

However, this traditional arrangement has a problem which has been identified by the Applicants. As noted above, the distance between the two cameras is set such that the maximum positive distance between the two images displayed on a screen of a particular size is the interpupilary distance. In other words, objects in the right image should appear no more than the interpupilary distance to the right of objects in the left image. Therefore, if the images captured by the cameras on the rig are to be displayed on a different sized screen, the 3 dimensional effect may be lost or the distance between the displayed images may exceed the interpupilary distance. In other words, if the images are captured by a camera rig whose arrangement is set so that the distance between the camera elements is appropriate for display of the stereoscopic image on a cinema screen, then the captured images will not be appropriate for display of the stereoscopic images on a television screen.

It is an aim of the present invention to alleviate this problem.

### SUMMARY OF THE INVENTION

According to a first aspect, there is provided a method of creating a stereoscopic image for display comprising the steps of: receiving a first image and a second image of the same scene captured from the same location, the second image being displaced from the first image by an amount; and transforming the second image such that at least some of the second image is displaced from the first image by a further amount; and outputting the first image and the transformed second image for stereoscopic display.

This is advantageous because different disparity effects can be applied to different objects within the image. This allows images which are captured in a manner suitable for display on one size of screen to be displayed on other, varying, sizes of screen.

The further amount may be determined in accordance with the size of the screen upon which the first image and the transformed second image will be stereoscopically displayed.

The further amount may be determined in accordance with the distance of the viewer from the screen upon which the first image and the transformed second image will be stereoscopically displayed.

The method may further comprise the step of: obtaining distance data indicative of the distance between an object in the scene being captured and the first and/or second camera element, wherein the further amount is determined in accordance with the obtained distance data.

The obtaining step may include a calibration step to obtain calibration data, the calibration step may then comprise measuring the displacement in the captured first and second image of an object placed in the scene being captured at a predetermined distance from the first and/or second camera element.

The obtaining step may include a calibration step of obtaining, from a storage means, calibration data, wherein the calibration data defines a relationship between the displacement in the captured first and second image of an object placed a predetermined distance from the first and/or second camera element and at least one camera parameter associated with the first and/or second camera element.

Following calibration, the obtaining distance data step may comprise measuring the displacement in the captured first and second image of an object whose distance from the cameras is to be obtained, and determining the distance between the object and the camera in accordance with the measured displacement and the calibration data.

The method may further comprise the step of: segmenting an object from the first image, wherein the object is segmented from the first image using the obtained distance data.

The distance data may be obtained from a predetermined depth map.

The method may further comprise the step of: comparing the first image and a transformed version of at least part of the first image, wherein the amount of transformation is determined in accordance with the distance data, and in accordance with this comparison, updating the distance data for the at least part of the first image.

The updated distance data may be used to determine the further amount.

According to another aspect, there is provided an apparatus for creating a stereoscopic image for display comprising: a receiver operable to receive a first image and a second image of the same scene captured from the same location, the second image being displaced from the first image by an amount; a transformer operable to transform the second image such that at least some of the second image is displaced from the first image by a further amount; and an interface operable to output the first image and the transformed second image for stereoscopic display.

The further amount may be determined in accordance with the size of the screen upon which the first image and the transformed second image will be stereoscopically displayed.

The further amount may be determined in accordance with the distance of the viewer from the screen upon which the first image and the transformed second image will be stereoscopically displayed.

The apparatus may further comprise an obtaining device operable to obtain distance data indicative of the distance between an object in the scene being captured and the first and/or second camera element, wherein the further amount is determined in accordance with the obtained distance data.

The obtaining device may be operable to obtain, from a storage means, calibration data, wherein the calibration data defines a relationship between the displacement in the captured first and second image of an object placed a predetermined distance from the first and/or second camera element and at least one camera parameter associated with the first and/or second camera element.

The obtaining device may include a calibration unit operable to obtain calibration data, the calibration device being operable to measure the displacement in the captured first and second image of an object placed in the scene being captured at a predetermined distance from the first and/or second camera element.

Following calibration, the obtaining device may be operable to measure the displacement in the captured first and second image of an object whose distance from the cameras is to be obtained, and to determine the distance between the object and the camera in accordance with the measured displacement and the calibration data.

The apparatus may further comprise: a segmenting device operable to segment an object from the first image, wherein the object is segmented from the first image using the obtained distance data.

Other respective features and or embodiments are defined in the appended claims.

### BRIEF DESCRIPTION OF THE DRAWINGS

The above and other objects, features and advantages of the invention will be apparent from the following detailed description of illustrative embodiments which is to be read in connection with the accompanying drawings, in which:

FIG. 1 describes a camera arrangement system according to an embodiment of the present invention;

FIG. 2 describes an image processing device used in the system of FIG. 1;

FIG. 3 is a schematic diagram of a system for determining the distance between two cameras and objects within a field of view of the cameras according to embodiments of the invention;

FIG. 4 is a schematic diagram of a system for determining the distance between two cameras and objects within a field of view of the cameras according to embodiments of the invention;

FIG. 5 shows a system for displaying images in accordance with embodiments of the invention so that the images can be viewed as three dimensional images by a user on screens of varying sizes;

FIG. 6 shows a diagram explaining an embodiment allowing the distance between two cameras and objects to be determined; and

FIG. 7 shows a schematic diagram of an embodiment for determining the distance between the cameras and an aerial object.

### DESCRIPTION OF THE PREFERRED EMBODIMENTS

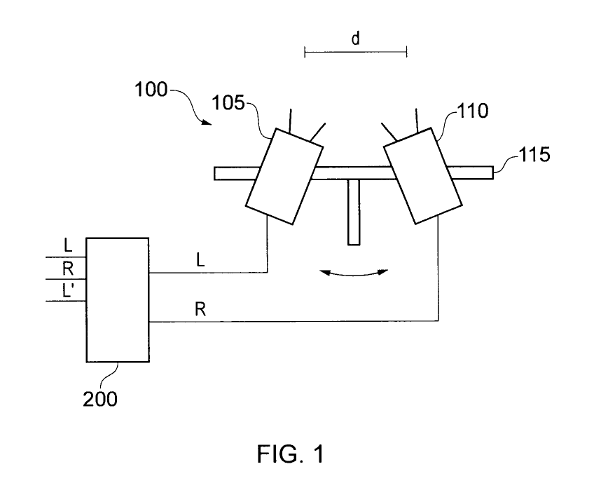

Referring to FIG. 1, a camera system 100 is shown. This system 100 has a camera rig 115 and an image processing device 200. On the camera rig 115 is mounted a first camera 105 and a second camera 110. The first camera 105 and the second camera 110 may be arranged to capture still or moving images. Both still and moving images will be referred to as “images” hereinafter. The first camera 105 captures a left image and the second camera 110 captures a right image. The left image and the right image are displayed simultaneously in a stereoscopic form such that the distance between the left image and the right image, when displayed on a screen of a certain size, is no greater than the interpupilary distance of around 6.5 cm. Thus, the distance d (which is often referred to as the “stereo base”) between the first camera 105 and the second camera 110 is set such that the distance between the left and right image, when displayed, is no greater than the interpupilary distance of the viewer. In order to achieve this, a typical value of d is around 12 cm for a binocular camera rig for display on a cinema screen. However, for display on a television screen, the value of d is around 60 cm. The pitch, yaw and roll of the camera rig 115 can be adjusted by a camera operator. The output of each camera is fed into the image processing device 200.

It is known how to set-up a binocular camera rig capable of capturing stereoscopic images. During the set-up of the binocular rig, the cameras are carefully aligned such that there is only a horizontal displacement between the captured images. After set-up, in embodiments of the present invention, the images captured by the first camera 105 and the second camera 110 are used to calculate the distance between the binocular camera rig and the objects of interest on the pitch. In order to calibrate the camera rig to perform this embodiment, an object is placed on the pitch at a known distance from the camera rig. As would be appreciated by the skilled person, when the images of the object captured by the first camera 105 and the second camera 110 are stereoscopically viewed (i.e. are viewed together), the image of the object captured by the first camera 105 and the image of the object captured by the second camera 110 are substantially the same except for a visual horizontal displacement which is a consequence of the horizontal displacement between the cameras. The visual horizontal displacement distance is determined during the calibration phase.

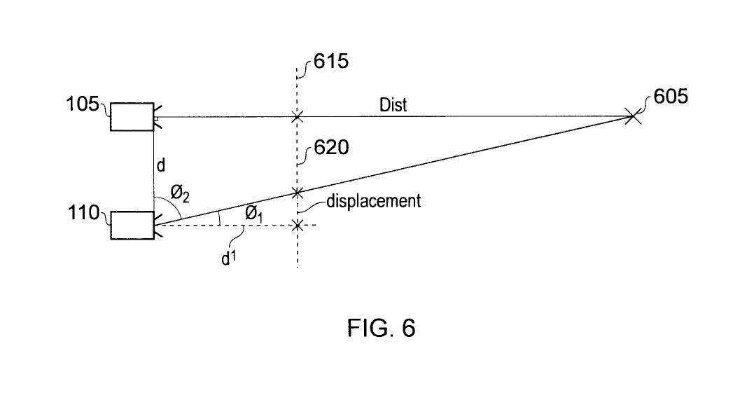

After calibration, in embodiments, the arrangement of the first camera 105 and the second camera 110 is used to calculate the distance between one or more objects on the pitch and the camera rig. The calculation of the distance between the camera rig and the objects of interest on the pitch will be explained later with reference to FIG. 6.

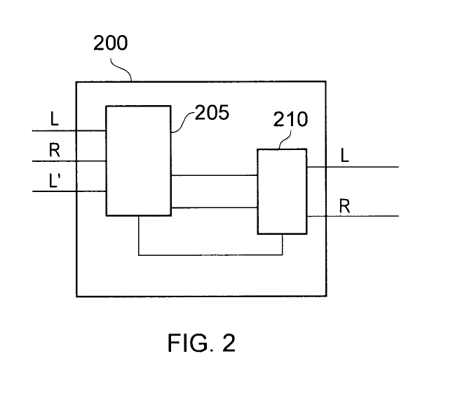

The image processing device 200 is described with reference to FIG. 2. The image processing device 200 comprises a storage medium 210 connected to a processing unit 205. Three feeds L, R and L′ are output from the processing unit 205. L is the output feed from the first camera element 105. R is the output feed from the second camera element 110 and L′ is a transformed version of the output feed from the first camera 105. The resultant stereoscopic image is then generated from either the output feeds L and R from the first camera 105 and second camera 110 respectively or from the transformed version of the output feed L′ from the first camera 105 and the output feed R from the second camera 110. The selection of either the combination L and R or L′ and R is dependent upon the size of the screen on which the stereoscopic image is displayed. This is because the amount of horizontal transformation applied in output feed L′ is dependent upon the size of the screen upon which the stereoscopic image is to be displayed. Moreover, the selection of output feeds and thus the amount of transformation applied in output feed L′ can be dependent upon the distance from the screen of the viewer. Therefore, in embodiments, the transformation applied to the output feed from the first camera 105 is dependent upon the size screen on which the stereoscopic image is to be displayed and/or the distance from the screen of the viewer. It should be noted that although only one transformed version of the output feed is described, the invention is not so limited. Indeed, any number of transformed versions can be generated meaning that any number of sizes and/or distances from the screen can be accommodated.

The storage medium 210 has stored thereon the output feed from the first camera element 105 and the output feed from the second camera element 110. Additionally, stored on the storage medium 210 is the transformed version of the output feed from the first camera element 105. In embodiments, a depth map (which will be explained later) is also stored on the storage medium 210. However, the depth map may be generated in real-time using data obtained from the first camera 105 and the second camera 110. This real-time generation is carried out by the processing unit 205 within the image processing device 200 as will also be explained later and, if carried out in real time means that no depth map need be stored. This saves storage space. The storage medium 210 may be a magnetic readable device, an optical readable medium, a semiconductor device or the like. Also, the storage medium 210 may be one storage element or a plurality of storage elements, any number of which may be removable from the image processing device 200. Clearly, although the storage medium 210 is described as being part of the image processor 200, the invention is not so limited. The storage medium 210 may be located outside of the image processing device 200 and may be connected thereto using a wired or wireless connection.

As noted earlier, the separation between the first camera 105 and the second camera 110 on the camera rig 115 is d cm. This distance is set to ensure that, when viewed, the maximum positive separation between the two images does not exceed the interpupilary distance of 6.5 cm. So, for example the objects in the right image should appear no more than 6.5 cm to the right of the objects in the left image. As noted above, the separation between the first and second camera therefore also may depend on the ratio of screen sizes on which the image is to be displayed. So, a scene captured for display on a cinema screen is not suitable for subsequent display on a television screen. This is because the size of a cinema screen is much greater than that of a television screen. For example, if we assume that the cinema screen is 20 times larger than a television screen then a scene is captured for viewing on a cinema screen (with a maximum positive disparity of 6.5 cm) will look disappointing on a television screen because the disparity (in terms of the number of pixels) between the two images will be very small. This will appear to be an unclear image rather than having a 3D effect. This means that the stereo base (i.e. separation between the first camera and the second camera) for a cinema screen is much smaller than for a television when capturing the same scene. This means that the stereo base for capturing a scene to be displayed on a cinema screen is not suitable for capturing the scene for display on a television screen.

In order to provide the adequate separation, the captured left image, L, is transformed in the image processing device 200 to generate transformed image L′. In particular, the image processing unit 205 generates the transformed image L′ using distance information obtained from either the depth map stored in the storage medium 210 or from the distance information calculated from both captured images as will be explained later. In particular, the image processing unit 205 may obtain position data identifying the position of each object in the image using known techniques such as that described in EP2034441A. From this position data, and the depth map, it is possible to determine the distance between the object in the scene and the camera which is capturing the image. In order to take account of the separation of the cameras, the offset between the captured right image R and the captured left image L is measured. In order to generate the transformed left image L′, a multiple amount of the transformation is then applied that is appropriate for the size of the display on which the images are to be displayed. For example, in the above case where the cinema screen is 20 times the size of the television screen, a transform of 19 times that separation is applied to the left image to produce the transformed left image. Moreover, this separation may be checked against the depth map to correct for any incorrect initial offset in the separation of the cameras.

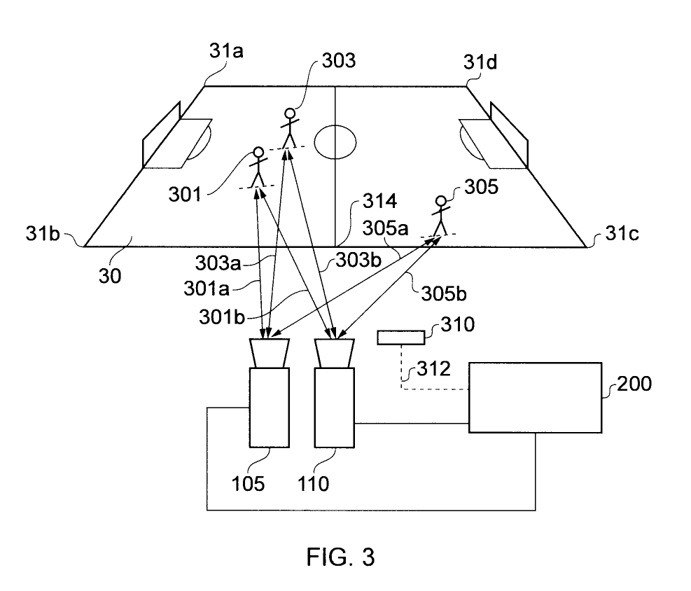

In order to generate transformed image L′, an offset transformation is applied to the captured left image, L. Embodiments of the present invention in which a distance between a camera and an object within an image captured by the camera is used to determine the offset amount will now be described with reference to FIGS. 3 to 5.

FIG. 3 is a schematic diagram of a system for determining the distance between a position of the camera rig and objects within a field of view of the camera in accordance with embodiments of the present invention.

The image processing device 200 is arranged to communicate with the first camera 105 and the second camera 110. The image processing device 200 is operable to analyse the images captured by the first camera 105 and the second camera 110 so as to track players on the pitch 30, and determine their position on the pitch 30. This may be achieved using a distance detector 310 operable to detect a distance between the first camera 105 and the second camera 110 and objects within the field of view of the camera. The distance detector 310 and its operation will be explained in more detail later below. Alternatively, the distance between the objects within the field of view of the cameras may be determined using image data provided by both cameras as will also be explained later.

In some embodiments, the image processing device 200 uses the tracking data and position data to determine a distance between a position of the first camera 105 and the second camera 110 and players on the pitch. For example, the image processing device analyses the captured image so as to determine a distance 301a between a position of the first camera 105 and a player 301, a distance 303a between the position of the first camera 105 and a player 303, and a distance 305a between the position of the first camera 105 and a player 305. The image processor 200 also analyses the captured image so as to determine a distance 301b between a position of the second camera 110 and a player 301, a distance 303b between the position of the second camera 110 and a player 303, and a distance 305b between the position of the second camera 110 and a player 305.

In other words, embodiments of the invention determine the distance between the object within the scene and a reference position defined with respect to the cameras. In the embodiments described with reference to FIG. 3, the reference position is located at the position of each respective camera.

Additionally, in some embodiments, the image processing device 200 is operable to detect predetermined image features within the captured image which correspond to known feature points within the scene. For example, the image processing device 200 analyses the captured image using known techniques so as to detect image features which correspond to features of the football pitch such as corners, centre spot, penalty area and the like. Based on the detected positions of the detected known feature points (image features), the image processing device 200 maps the three dimensional model of the pitch 30 to the captured image using known techniques. Accordingly, the image processing device 200 then analyses the captured image to detect the distance between the camera and the player in dependence upon the detected position of the player with respect to the 3D model which has been mapped to the captured image.

In some embodiments of the invention, the image processing device 200 analyses the captured images so as to determine a position at which the player's feet are in contact with the pitch. In other words, the image processing device 200 determines an intersection point at which an object, such as a player, coincides with a planar surface such as the pitch 30. It should be noted here that in this situation, if the player leaves the pitch (for example, when jumping), the accuracy of the determined position reduces because they are no longer on the pitch. Similarly, if the ball position is determined in a similar manner, when the ball is kicked in the air, the accuracy of the determined position is reduced. Embodiments of the present invention aim to also improve the accuracy of the obtained distance between the respective cameras and aerial objects.

Where an object is detected as coinciding with the planar surface at more than one intersection point (for example both of the player's feet are in contact with the pitch 30), then the image processing device 200 is operable to detect which intersection point is closest to the respective cameras 105, 110 and uses that distance for generating the offset amount. Alternatively, an average distance of all detected intersection points for that object can be calculated and used when generating the offset amount. However, it will be appreciated that other suitable intersection points could be selected, such as an intersection point furthest from the respective cameras 105, 110.

However, in some situations, the method of determining the distance between position of the respective cameras 105, 110 and the object within the scene as described above may cause distortions in the appearance of the three-dimensional image. Such distortions may be particularly apparent if the image is captured by a very wide angle camera or formed by stitching together images captured by two high definition cameras.

For example, image distortions in the three-dimensional image may occur if the pitch 30 is to be displayed as a three-dimensional image upon which the players and the ball are superimposed. In this case, corners 31b and 31c will appear further away than a centre point 314 on the sideline closest to the cameras. The sideline may thus appear curved, even though the sideline is straight in the captured image.

This effect can be particularly apparent when the three-dimensional image is viewed on a relatively small display such as a computer monitor. If the three-dimensional image is viewed on a comparatively large screen such as a cinema screen, this effect is less obvious because the corners 31b and 31c are more likely to be in the viewer's peripheral vision. The way in which the pitch may be displayed as a three-dimensional image will be described in more detail later below.

A possible way to address this problem would be to generate an appropriate offset amount for each part of the image so as to compensate for the distortion. However, this can be computationally intensive, as well as being dependent on several physical parameters such as degree of distortion due to wide angle image, display size and the like.

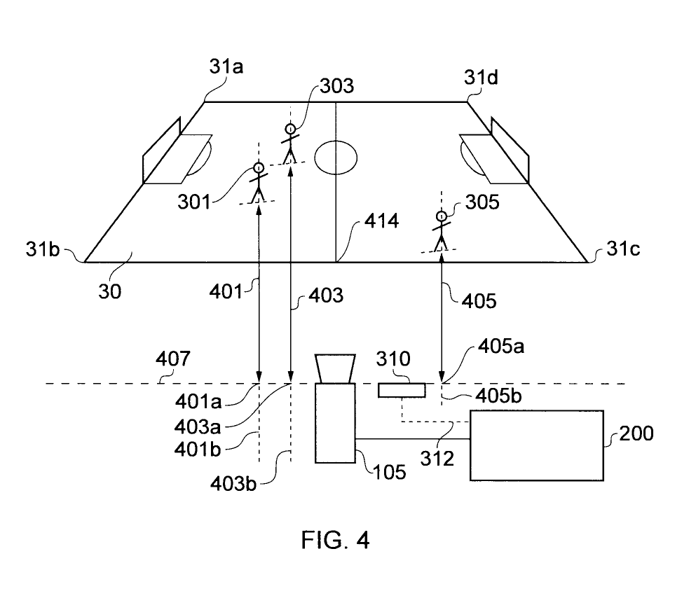

Therefore, to reduce distortion in the three-dimensional image and to try to ensure that the front of the pitch (i.e. the sideline closest to the camera) appears at a constant depth from the display, especially when the three-dimensional image is to be viewed on a relatively small display such as a computer monitor or television screen, embodiments of the invention determine the distance between the object and a reference position which lies on a reference line. The reference line is orthogonal to the optical axis of the camera and passes through a position of the cameras, and the reference position is located on the reference line at a point where an object location line and the reference line intersect. The object location line is orthogonal to the reference line and passes through the object. This will be described below with reference to FIG. 4.

FIG. 4 is a schematic diagram of a system for determining the distance between a camera and objects within a field of view of the camera in accordance with embodiments of the present invention. It should be noted here that only the first camera 105 is shown. However, this is for brevity and the same technique will be applied to the second camera 110 as would be appreciated. The embodiment shown in FIG. 4 is substantially the same as that described above with reference to FIG. 3. However, in the embodiments shown in FIG. 4, the image processing device 200 is operable to determine a distance between an object and a reference line indicated by the dashed line 407.

As shown in FIG. 4, the reference line 407 is orthogonal to the optical axis of the first camera 105 (i.e. at right angles to the optical axis) and passes through the position of the first camera 105. Additionally, FIG. 4 shows reference positions 401a, 403a, and 4005a which lie on the reference line 407.

For example, the image processing device 200 is operable to determine a distance 401 between the reference position 401a and the player 301. The reference position 401a is located on the reference line 407 where an object reference line (indicated by dotted line 401b) for player 301 intersects the reference line 407. Similarly, the reference position 403a is located on the reference line 407 where an object reference line (indicated by dotted line 403b) for player 303 intersects the reference line 407, and the reference position 405a is located on the reference line 407 where an object reference line (indicated by dotted line 405b) intersects the reference line 407. The object reference lines 401b, 403b, and 405b are orthogonal to the reference line 407 and pass through players 301, 303 and 305 respectively.

In some embodiments, the reference line 407 is parallel to the sideline which joins corners 31b and 31c so that, when a captured image of the pitch and a modified image of the pitch are viewed together on a display in a suitable manner, all points on the side line joining corners 31b and 31c appear as if at a constant distance (depth) from the display. This improves the appearance of the three-dimensional image without having to generate an offset amount which compensates for any distortion which may arise when the image is captured using a wide angle camera or from a composite image formed by combining images of different fields of views captured by two or more cameras. However, it will be appreciated that the reference line need not be parallel to the sideline, and could be parallel to any other appropriate feature within the scene, or arranged with respect to any other appropriate feature within the scene.

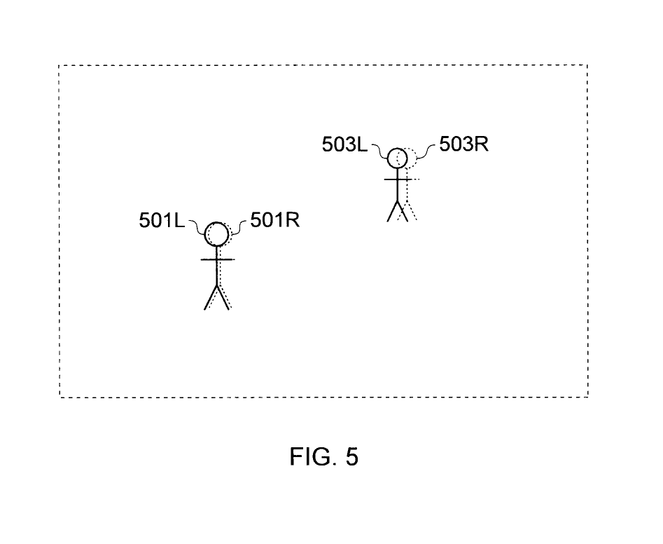

In order for images to be generated such that, when viewed, they appear to be three-dimensional, the image processing device 200 is operable to detect a position of an object such as a player within the captured image. The way in which objects are detected within the image by the image processor 200 will be described later. The image processing device 200 then generates a transformed left image from the captured left image by displacing the position of the object within the left image by the offset amount so that, when the transformed left image and the captured right image are viewed together as a pair of images on a television display, the object appears to be positioned at a predetermined distance from the television display. The way in which the captured right image and the transformed left image may be displayed together is illustrated in FIG. 5.

In particular, FIG. 5 shows images of the player 301 and the player 303 on the television display. The image captured by the second camera 110 is used to display a right-hand image 501R (illustrated by the dashed line) corresponding to the player 301 as well as a right-hand image 503R (illustrated by the dashed line) of the player 303. The right-hand images are intended to be viewed by a user's right eye, for example by the user wearing a suitable pair of polarised or shutter glasses. The image processing device 200 generates a transformed version of the left image comprising each object. FIG. 5 shows a transformed left-hand image SOIL corresponding to the player 301, and a transformed left-hand image 503L corresponding to the player 303. For example, when the left-hand image 301L is viewed together with the right-hand image 301R on the television display, the player 301 will appear as if positioned at a predetermined distance from the television display. It should be noted here that if the left and right hand images were to be displayed on a cinema screen (i.e. on a screen for which the camera rig was calibrated), then the captured left hand image (rather than the transformed left hand image as for the television screen) and the captured right hand image would be displayed.

In order to generate the transformed left-hand image the image processing device 200 generates a mask which corresponds to an outline of the object, such as the player in the captured left-hand image. This is known. The image processing device 200 is then operable to apply the offset amount image offset to pixels within the mask, so as to generate the transformed left-hand image. This is carried out in respect of each object which is detected within the captured left-hand image.

The offset amount for each player is dependent upon the distance between the camera and the player. For example, as shown in FIG. 3, player 301 is closer to the camera than player 303. Therefore, for a given distance (d_{S}) between the display and the user, the offset amount between the transformed left-hand image 501L and the right-hand image 501R corresponding to player 301 will be smaller than the offset amount between the transformed left-hand image 303L and the right-hand-image 303R corresponding to player 303. The apparent distance of each object can be scaled appropriately as desired, for example, so as to be displayed on a particular size of display.

It will be appreciated that in some circumstances, for example with football players on a football pitch, it may be undesirable to cause a player to appear in three dimensions at a distance from the display which corresponds to the actual distance from the cameras, as this may cause an unpleasant viewing experience for a user. Additionally, this may lose some of the three-dimensional effect if an object is rendered so as to appear tens of metres from the display. Therefore, in embodiments of the invention, the image processing device 200 is operable to detect what percentage of the captured image in the vertical direction is occupied by the football pitch and scale the apparent object depth accordingly.

For example, the image processing device 200 detects a position of a sideline of the football pitch 30 which is closest to the cameras, as well as detecting a position of a sideline of the football pitch 30 which is furthest from the cameras, based on the mapping of the 3D model to the captured left-hand image. The image processing device 200 then generates the offset amount accordingly so that objects which are at the same distance from the cameras as the nearest sideline appear as if at the same distance from the user as the display.

The distance at which the farthest sideline appears from the display can then be set by the image processing device 200 to be a distance corresponding to a vertical height of the display. However, it will be appreciated that any other suitable method of scaling the apparent object depth may be used.

Additionally, it will be appreciated that it is the physical distance between the right-hand image and the transformed left-hand image on the display which causes the object to appear as if at a predetermined distance from the display. Therefore, in embodiments of the invention, the offset amount is initially calculated in physical units of measurement, such as millimetres. When generating the transformed left-hand image for rendering as pixels on the display, the value of the offset amount in millimetres is scaled by the image processing device 200 in dependence on any or all of: the size of display; the resolution of the display in pixels; and pixel pitch. These parameters may be stored in a look-up table which stores the relevant parameters for different types of display (e.g. by manufacturer and model number), or they may be input by a user.

In some embodiments, the image processing device 200 causes the display to display a calibration sequence of images which allows a user to provide feedback via a suitable input means as to whether, for example, an object appears at infinity, at the television screen distance, and distances in between infinity and the user. However, it will be appreciated that other suitable methods of scaling the right-hand and transformed left-hand images for output on a display may be used.

As described above, in some embodiments, the distance between the cameras and the intersection point associated with an object may be determined by the image processing device 200. Accordingly, in some embodiments, the offset amount may be generated in dependence upon the distance between the cameras and the intersection point for that object and applied as the offset amount for the whole of that object. In other words, a player would appear two-dimensional but would appear as if positioned in three dimensions on the football pitch at a predetermined distance from the television display. This advantageously reduces processing resources as the distance to each point on a player corresponding to an output pixel on the television display does not have to be detected and used to generate a respective offset amount.

In some embodiments, the image processing device 200 is operable to map a three-dimensional model of a stadium comprising the football pitch 30 to the captured left-hand image so that the image processing device 200 can generate an appropriate offset amount for each pixel in the captured left-hand image corresponding to the stadium so as to cause the stadium and/or pitch 30 to appear as a three-dimensional image when viewed on the display. As the stadium and pitch are relatively static with respect to the cameras, generation of the respective offset amounts for each pixel in the captured left-hand image may be carried out when the background left-hand image is generated, or it may be carried out periodically, so as to reduce processing resources.

In order to reduce the likelihood that undesirable image artefacts may occur in the transformed image when the transformed left-hand image is combined with the background left-hand image, in some embodiments, the image processing device 200 is operable to generate a background left-hand image of the pitch 30 for each captured frame. This allows adjustment of the background left-hand image in accordance any change in lighting or shadows on the pitch 30. However, it will be appreciated that the background left-hand image may be generated and updated at any other suitable frame interval, for example, every other frame.

The image processing device 200 is operable to map the three-dimensional model of the pitch to the left-hand image and generate an appropriate offset amount for each pixel corresponding to the pitch as described above so as to generate a background left-hand image. The image processing device 200 then combines the transformed left-hand image corresponding to an object such as a player with the modified background left-hand image so as to generate a combined modified image. For example, the image processing device 200 generates the combined modified image by superimposing the modified left hand image corresponding to an object on the background left-hand image. When the captured right-hand image and the combined modified left-hand image are viewed together on a display in a suitable manner, they will appear to the user as if they are a three-dimensional image whose offset is suited for the size of the display and/or for the distance of the viewer from the screen.

As noted above the captured left-hand image is transformed to provide the offset appropriate for display on a television and displayed with the captured right-hand image. This provides an additional advantage. By transforming the captured left-hand image and displaying this with the captured right-hand image, the objects on the pitch look more realistic as they are displayed having depth to the object. In other words, as an alternative one could capture the scene with one camera and “cut-out” the objects and apply the transform to that object to produce a stereoscopic image. Now, although this would produce the appropriate three dimensional effect for that object, the three dimensional object would look flat. This is because the image of the object is captured from one location. However, in the embodiment where the captured left hand image is transformed, the object is captured from two slightly different directions. This means each captured object will have some depth perception. This means that when displayed, the 3D objects will appear more realistic. This is particularly advantageous when capturing objects in a scene that are close to the cameras (for example less than 10 m from the cameras).

### Distance Calculation

As noted above, in order to generate the transformed left image, the distance between the object on the pitch and the cameras is required. There are a number of ways in which the distance between the object on the pitch 30 and the cameras may be determined. In some embodiments of the invention, the system comprises a distance detector 310. The distance detector may be either coupled to one or both of the cameras or it may be separate to the cameras. The distance detector is operable to generate distance data indicative of the distance between the camera(s) and any object on the pitch. The distance detector sends the distance data to the image processing device 200. The image processing device 200 then determines the distance between the camera and the object in dependence upon the distance data received from the distance detector. In other words, the distance detector acts as a distance sensor. Such sensors are known in the art and may use infrared light, ultrasound, laser light and the like to detect distance to objects.

Additionally, it is possible that a depth map is also generated during the calibration stage. In this case, the depth map will be stored in the image processor 200. The depth map indicates, for each pixel of the captured image, a respective distance between the camera and a scene feature within the scene which coincides with that pixel. The distance data sent from the distance detector 310 to the image processing device 200 then comprises the depth map data.

To achieve this functionality, the distance detector 310 may comprise an infrared light source which emits a pulse of infrared light. One or both of the cameras can then detect the intensity of the infrared light reflected from objects within the field of view of the camera at predetermined time intervals (typically of the order of nano-seconds) so as to generate a grey scale image indicative of the distance of objects from the camera. In other words, the grey scale image can be thought of as a depth map which is generated from detecting the time of flight of the infrared light from the source to the camera.

To simplify design, either cameras or the camera rig can comprise a distance detector in the form of an infrared light source. Such cameras are known in the art such as the “Z-Cam” manufactured by 3DV Systems. However, it will be appreciated that other known methods of generating 3D depth maps could be used, such as infrared pattern distortion detection.

In some embodiments, the image processing device 200 is operable to use the distance detector 310 to detect and track other objects in the field of view of either or both of the cameras 105, 110, such as a football, although it will be appreciated that any other suitable object could be detected. For example, images captured by one or more additional cameras may be analysed by the image processing device 200 and combined with data from the tracking system so as to track the football and generate appropriate left-hand and right-hand images accordingly.

Alternatively, it is possible to determine the distance of any number of objects on the pitch using the images captured by the first camera 105 and the second camera 110. This is described in detail below with reference to FIG. 6.

In FIG. 6, the first camera 105 and the second camera 110 are separated by a predetermined distance d. An object 305 is located on the pitch. During calibration, the object is located a known distance (dist) from the first camera 105. Also shown in FIG. 6 are a first image plane 615 and a second image plane 620. The first image plane 615 is the image plane for the first camera 105 and the second image plane 620 is the image plane of the second camera 110. In reality the first and second image planes would be located in the first camera 105 and the second camera 110 respectively. Specifically, in embodiments the image planes would be the CMOS or CCD image capture element of each camera. However, for illustrative purposes, the first and second image planes 615 and 620 are located outside of the first camera 105 and the second camera 110 by a distance d′.

As noted earlier, during calibration, the distance d between the first camera 105 and the second camera 110 is measured. Additionally, the distance (dist) between the first camera 105 and the calibration object 605 is obtained. Also, the value of displacement is obtained.

Using trigonometry, it is known that

$$\begin{matrix}tan ( φ1 ) = \frac{displacement}{{d}^{′}} & ( 1 ) \\ φ 2 = \frac{π}{2} - φ 1 & ( 2 ) \\ tan ( φ 2 ) = \frac{Dist}{d} & ( 3 )\end{matrix}$$

Therefore, it can be seen that during calibration, it is possible to calculate a value for d′. Specifically,

$${d}^{′} = \frac{displacement}{tan ( \frac{π}{2} - {tan}^{- 1} ( \frac{Dist}{d} ) )} \qquad ( 4 )$$

As d′ and d do not vary after the first camera 105 and the second camera 110 have been calibrated, it is possible to calculate the distance of any object knowing the displacement. In other words, it is possible to calculate the distance of the object from the aligned cameras knowing the distance between the position of the object on the first image plane 615 and the second image plane 620. This is achieved using equation (6) below.

$$Dist = tan ( \frac{π}{2} - {tan}^{- 1} ( \frac{displacement}{{d}^{′}} ) ) * d \qquad ( 5 )$$

This is useful because for each captured frame it is possible to calculate the distance of each object in the captured frame from the aligned cameras “on the fly”, or in real-time. This means that the depth map does not need to be stored in the image processor 200 and so by generating the value, dist, in real-time saves storage space.

It should be also noted that in the discussion of FIG. 6, it is possible to calculate the displacement by using techniques such as block matching to compare the position of an object in the left and right images as would be appreciated by the skilled person.

As an alternative to the calibration scheme described in FIG. 6, it is possible to determine the relationship between displacement and distance to object for various known camera set ups. These would be stored and would be selected based on any combination of the following camera parameters which are camera position, orientation, focal length and lens characteristics.

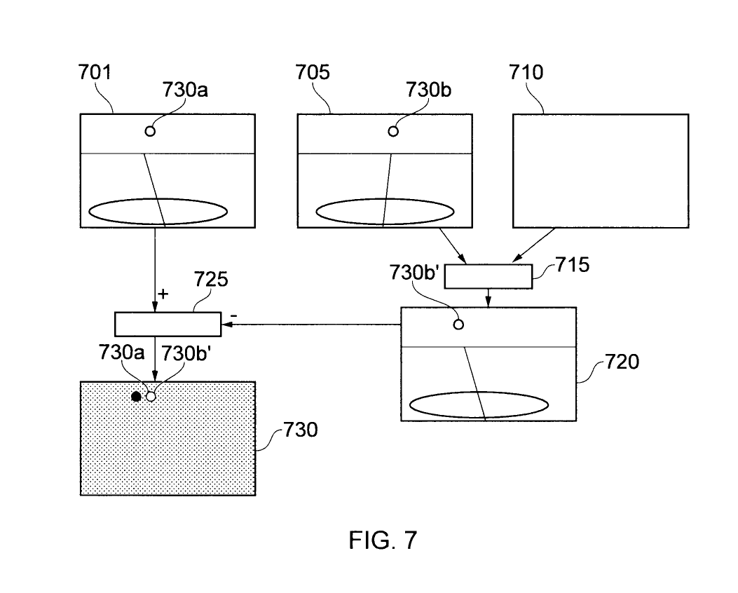

As noted above, it is possible to improve the accuracy of the calculation of an aerial object. This is described with reference to FIG. 7.

In FIG. 7, the captured left image 701 and the captured right image 705 is shown. These images are captured by the first camera 105 and the second camera 110 respectively. Additionally shown in FIG. 7 is the depth map 710. In the captured left image 701 is a representation of ball 730a which is in the air. Also in the captured right image is a representation of the ball 730b. As noted above, it is possible to synthesise a version of the left image using the right hand image. In order to do this, the right image is transformed by an amount determined by the depth map. This takes place in synthesiser 715 which is located in the image processor 200. In the synthesised left image 720 is the synthesised position of the ball 730b′. As noted above, as the ball is in the air, the position of the ball may not be accurately determined. This is because its depth, as recorded in the depth map, may be incorrect.

The synthesised left image 720 is then fed into a difference calculator 725. Also fed into the difference calculator 725 is the captured left image 701. Therefore, the output of the difference calculator shows all objects in the captured left image and the synthesised left image which do not match. The output of the difference calculation is shown in 730. In output 730 there are two ball images 730a and 730b′. This means that there is an error in the distances determined by the depth map. It is known from literature such as UK patent application GB0902841.6 filed by Sony Corporation and other documents available at the time of filing this application, that the offset amount, i, which is the amount by which the left and right image are offset from one another, can be calculated using equation (6) below.

$$i = p \cdot ( \frac{do - ds}{do} ) \qquad ( 6 )$$

Where p is the interpupilary distance, do is the apparent object depth and ds is the distance between the viewer's eyes and the screen.

Considering this equation for the synthesised left image we have:

$$i 1 = p \cdot ( \frac{do 1 - do}{do 1} ) \qquad ( 7 )$$

where i1 is the amount by which the synthesised left image is offset from the captured right image and do1 is the apparent object depth resulting from this offset (obtained from the depth map, 710).

Now considering the equation for the captured left image we have:

$$i 2 = p \cdot ( \frac{do 2 - ds}{do 2} ) \qquad ( 8 )$$

where i2 is the amount by which the captured left image is offset from the captured right image and do2 is the apparent object depth resulting from this offset.

To replace the incorrect value, do 1 in the depth map with the correct value, do2, it is noted that the observable difference between the two ball images 730a and 730b′ is:

ierror=i2−i1 (9)

Substituting i1 for the expression in equation (7) and i2 for the expression in equation (8) and simplifying gives:

$$ierror = p \cdot ds \cdot \frac{do 2 - do 1}{do 1 \cdot do 2} \qquad ( 10 )$$

Rearranging equation (10) now gives:

$$do 2 = \frac{p \cdot ds \cdot do 1}{p \cdot ds - ierror \cdot do 1} \qquad ( 11 )$$

Therefore, by knowing ierror (which is the error in the distances) and do1 (from the depth map 710 used to calculate the synthesised left image) and assuming a value for p and ds (these will be the same values as used in calculating the offset amount in the synthesised image), it is possible to calculate do2. The value of do2 is used to replace the incorrect value do1 in the depth map at the ball position for that frame. Therefore, an appropriate amount of correction can be applied to the ball during generation of the transformed object.

After the distance of the ball from the camera has been calculated, an appropriate displacement offset is applied to the ball. The displacement offset is applied in a similar manner to that described above. However, as the distance between the camera and the ball is more accurately determined, a more appropriate offset can be applied to the ball. This improves the realism of the applied 3D effect.

Although the foregoing has been described by referring to hardware, it is possible that the invention may embodied as computer software. In this case, the computer program will contain computer readable instructions which, when loaded onto a computer, configure the computer to perform the invention. This computer program may be stored on a computer readable medium such as a magnetic readable medium or an optical disk. Indeed, the computer program may be stored on, or transferred over, a network as a signal.

Although the foregoing has been noted as transforming the image from the left-hand camera, the invention is not so limited. The image from the right-hand camera, or indeed from both cameras may also be transformed. Also, although the foregoing has been described as referring to two separate cameras, the invention is not so limited. The invention may be embodied on a single lens camera which is arranged to capture stereoscopic images. For example, Sony® has developed the HFR-Comfort 3D camera which is a single lens camera capable of capturing 3 dimensional images. So, where the foregoing refers to a first camera and a second camera, the invention could be implemented on a first camera element and a second camera element both located in the single lens 3D camera.

Although the foregoing has been explained with reference to the left image being transformed in dependence on the screen size, the invention is not so limited. In particular, in certain embodiments, different 3D zoom effects can be applied to different objects. For example, during display of a sports event, the disparity applied to a player of interest may be different to replicate a 3D zoom effect on that player.

Further, the above has been described with reference to increasing the amount of displacement between objects. However, the invention is not so limited. It is apparent that the principles explained above can also be applied to reducing the displacement between the objects. In other words, it is possible to adjust the displacement between the objects to increase or decrease the displacement between the objects by a further amount.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

We claim:

1. A method of creating a stereoscopic image for display comprising the steps of: receiving a first image and a second image of the same scene captured from the same location, the second image being displaced from the first image by an amount; and transforming the second image such that at least some of the second image is displaced from the first image by a further amount; and outputting the first image and the transformed second image for stereoscopic display.

2. A method according to claim 1, wherein the further amount is determined in accordance with the size of the screen upon which the first image and the transformed second image will be stereoscopically displayed.

3. A method according to claim 1, wherein the further amount is determined in accordance with the distance of the viewer from the screen upon which the first image and the transformed second image will be stereoscopically displayed.

4. A method according to claim 1, further comprising the step of: obtaining distance data indicative of the distance between an object in the scene being captured and the first and/or second camera element, wherein the further amount is determined in accordance with the obtained distance data.

5. A method according to claim 4, wherein the obtaining step includes a calibration step to obtain calibration data, the calibration step comprising measuring the displacement in the captured first and second image of an object placed in the scene being captured at a predetermined distance from the first and/or second camera element.

6. A method according to claim 4, wherein the obtaining step includes a calibration step of obtaining, from a storage device, calibration data, wherein the calibration data defines a relationship between the displacement in the captured first and second image of an object placed a predetermined distance from the first and/or second camera element and at least one camera parameter associated with the first and/or second camera element.

7. A method according to claim 5 or 6, wherein following calibration, the obtaining distance data step comprises measuring the displacement in the captured first and second image of an object whose distance from the cameras is to be obtained, and determining the distance between the object and the camera in accordance with the measured displacement and the calibration data.

8. A method according to claim 4, wherein the distance data is obtained from a predetermined depth map.

9. A method according to claim 4, further comprising the step of: comparing the first image and a transformed version of at least part of the first image, wherein the amount of transformation is determined in accordance with the distance data, and in accordance with this comparison, updating the distance data for the at least part of the first image.

10. A method according to claim 9, wherein the updated distance data is used to determine the further amount.

11. An apparatus for creating a stereoscopic image for display comprising: a receiver operable to receive a first image and a second image of the same scene captured from the same location, the second image being displaced from the first image by an amount; a transformer operable to transform the second image such that at least some of the second image is displaced from the first image by a further amount; and an interface operable to output the first image and the transformed second image for stereoscopic display.

12. An apparatus according to claim 11, wherein the further amount is determined in accordance with the size of the screen upon which the first image and the transformed second image will be stereoscopically displayed.

13. An apparatus according to claim 11, wherein the further amount is determined in accordance with the distance of the viewer from the screen upon which the first image and the transformed second image will be stereoscopically displayed.

14. An apparatus according to claim 11, further comprising an obtaining device operable to obtain distance data indicative of the distance between an object in the scene being captured and the first and/or second camera element, wherein the further amount is determined in accordance with the obtained distance data.

15. An apparatus according to claim 14, wherein the obtaining device includes a calibration device operable to obtain calibration data, the calibration device being operable to measure the displacement in the captured first and second image of an object placed in the scene being captured at a predetermined distance from the first and/or second camera element.

16. An apparatus according to claim 14, wherein the obtaining device is operable to obtain, from a storage device, calibration data, wherein the calibration data defines a relationship between the displacement in the captured first and second image of an object placed a predetermined distance from the first and/or second camera element and at least one camera parameter associated with the first and/or second camera element.

17. An apparatus according to claim 15 or 16, wherein following calibration, the obtaining device is operable to measure the displacement in the captured first and second image of an object whose distance from the cameras is to be obtained, and to determine the distance between the object and the camera in accordance with the measured displacement and the calibration data.

18. An apparatus according to claim 15, wherein the distance data is obtained from a predetermined depth map.

19. An apparatus according to claim 15, further comprising: a comparing unit operable to compare the first image and a transformed version of at least part of the first image, wherein the amount of transformation is determined in accordance with the distance data, and in accordance with this comparison, updating the distance data for the at least part of the first image.

20. An apparatus according to claim 19, wherein the updated distance data is used to determine the further amount.

21. A computer program containing computer readable instructions which, when loaded onto a computer, configure the computer to perform a method according to claim 1.

22. A storage medium configured to store the computer program of claim 21 therein or thereon.
